(19) United States
(12) Patent Application Publication
(10) Pub. No.: US 2014/0343753 A1
(43) Pub. Date: Nov. 20, 2014

(54) SYSTEM AND METHOD FOR VEHICLE INTERFACE EXTENSION AND CONTROL

(71) Applicant: Honda Motor Co., Ltd., Tokyo (JP)

(72) Inventor: David M. Kirsch, Torrance, CA (US)

(73) Assignee: Honda Motor Co., Ltd., Tokyo (JP)

(21) Appl. No.: 13/895,297

(22) Filed: May 15, 2013

(51) Int. Cl. B60R 16/023

(52) U.S. Cl. CPC B60R 16/0231
USPC 701/2

(57) ABSTRACT

A system and method for establishing connections from a vehicle telematics device to a plurality of portable devices including transmitting an interface data stream from the telematics device to the plurality of devices, the interface data stream enabling the portable devices to mirror an interface of the vehicle telematics device and functionality associated with said interface and updating the interface data stream upon detecting a change event.

### BACKGROUND

A connected vehicle is configured to provide wireless connectivity and interaction between the vehicle and the outside world. In particular, vehicle manufacturers are increasingly providing various means for interaction between vehicle systems and portable devices. As the demand for a more connected and mobile digital lifestyle continues to grow, intuitive and flexible handling between vehicle systems and portable devices is necessary to facilitate intelligent shared allocation of all things, including vehicles and portable devices.

### BRIEF DESCRIPTION

According to one aspect, a method for extending and controlling a vehicle telematics unit includes establishing connections from a vehicle telematics device to a plurality of portable devices and transmitting an interface data stream from the telematics device to the plurality of devices. The interface data stream enables the portable devices to mirror an interface of the vehicle telematics device and functionality associated with said interface. The method also includes updating the interface data stream upon detecting a change event.

According to another aspect, a method for extending and controlling a vehicle telematics device includes establishing a connection from a vehicle telematics device to a first portable device and from the first portable device to a plurality of other portable devices. The method also includes transmitting an interface data stream from the telematics device to the first portable device and from the first portable device to the other portable devices. The interface data stream enables the first portable device and other portable devices to mirror an interface of the vehicle telematics device and functionality associated with said interface. The method further includes updating the interface data stream upon detecting a change event.

According to a further aspect, a system for extending and controlling a vehicle telematics device includes a vehicle telematics device operably connected to a plurality of portable devices and a mirror link framework for extending an interface of the telematics device to the plurality of portable devices. The mirror link framework includes a control module for transmitting an interface data stream from the telematics device to the plurality of devices, the interface data stream enabling the portable devices to mirror an interface of the vehicle telematics device and functionality associated with said interface. The mirror link further includes an update module for updating the interface of the telematics device based on the control command.

According to still another aspect, a non-transitory machine-readable medium provides executable instructions that cause a computer to execute a method for extending and controlling a vehicle telematics device, the method including establishing connections from a vehicle telematics device to a plurality of portable devices and transmitting an interface data stream from the telematics device to the plurality of devices. The interface data stream enables the portable devices to mirror an interface of the vehicle telematics device and functionality associated with said interface. The method also includes updating the interface data stream upon detecting a change event.

### BRIEF DESCRIPTION OF THE DRAWINGS

FIG. 1A is a schematic view of a system for vehicle interface extension and control according to an exemplary embodiment;

FIG. 1B is a schematic view of a system for vehicle interface extension and control according to another exemplary embodiment;

FIG. 2A is a schematic view of a system for vehicle interface extension and control according to a further exemplary embodiment;

FIG. 2B is a schematic view of a system for vehicle interface extension and control according to still another exemplary embodiment;

FIG. 3 is a system architecture diagram of a telematics device of FIGS. 1A, 1B, 2A and 2B according to an exemplary embodiment;

FIG. 4 is a system architecture diagram of a portable device of FIGS. 1A, 1B, 2A and 2B according to an exemplary embodiment; and

FIG. 5 is a process flow diagram of a method for vehicle interface extension and control according to an exemplary embodiment.

### DETAILED DESCRIPTION

The following includes definitions of selected terms employed herein. The definitions include various examples and/or forms of components that fall within the scope of a term and that can be used for implementation. The examples are not intended to be limiting.

A “bus,” as used herein, refers to an interconnected architecture that is operably connected to other computer components inside a computer or between computers. The bus can transfer data between the computer components. The bus can a memory bus, a memory controller, a peripheral bus, an external bus, a crossbar switch, and/or a local bus, among others. The bus can also be a vehicle bus that interconnects components inside a vehicle using protocols such as Controller Area network (CAN), Local Interconnect Network (LIN), among others.

“Computer communication,” as used herein, refers to a communication between two or more computing devices (e.g., computer, personal digital assistant, cellular telephone, network device) and can be, for example, a network transfer, a file transfer, an applet transfer, an email, a hypertext transfer protocol (HTTP) transfer, and so on. Computer communication can occur using various wired and wireless protocols and technologies as is known in the art. For example, these can include a wireless system (e.g., IEEE 802.11, IEEE 802.15.1 (Bluetooth)), an Ethernet system (e.g., IEEE 802.3), a token ring system (e.g., IEEE 802.5), a near field communication system (NFC) (e.g., ISO 13157), a local area network (LAN), a wide area network (WAN), a point-to-point system, a circuit switching system, a packet switching system, a cellular network system (e.g., CDMA, GSM, LTE, 3G, 4G), a universal serial bus, among others. Computer communication can be indicated herein by a “communication link.”

A “machine-readable medium,” as used herein, refers to a medium that provides signals, instructions and/or data. A machine-readable medium can take forms, including, but not limited to, non-volatile media and volatile media. Non-volatile media can include, for example, optical or magnetic disks, and so on. Volatile media can include, for example, semiconductor memories, dynamic memory, and so on. Common forms of a machine -readable medium include, but are not limited to, a floppy disk, a flexible disk, a hard disk, a magnetic tape, other magnetic medium, other optical medium, a RAM (random access memory), a ROM (read only memory), and other media from which a computer, a processor or other electronic device can read.

A “storage,” as used herein can be, for example, a magnetic disk drive, a solid state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The storage can store an operating system that controls or allocates resources of a computing device.

A “memory,” as used herein can include volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system that controls or allocates resources of a computing device.

An “operable connection,” or a connection by which entities are “operably connected”, is one in which signals, physical communications, and/or logical communications can be sent and/or received. An operable connection can include a physical interface, a data interface and/or an electrical interface.

A “processor,” as used herein, processes signals and performs general computing and arithmetic functions. Signals processed by the processor can include digital signals, data signals, computer instructions, processor instructions, messages, a bit, a bit stream, or other means that can be received, transmitted and/or detected. Generally, the processor can be a variety of various processors including multiple single and multicore processors and co-processors and other multiple single and multicore processor and co-processor architectures. The processor can include various modules to execute various functions.

A “portable device,” as used herein, is a computing device typically having a display screen with user input (e.g., touch, keyboard) and a processor for computing. Portable devices include, but are not limited to, handheld devices, mobile devices, smart phones, laptops, tablets and e-readers.

A “vehicle,” as used herein, refers to any moving vehicle that is capable of carrying one or more human occupants and is powered by any form of energy. The term “vehicle” includes, but is not limited to: cars, trucks, vans, minivans, SUVs, motorcycles, scooters, boats, personal watercraft, and aircraft. In some cases, a motor vehicle includes one or more engines.

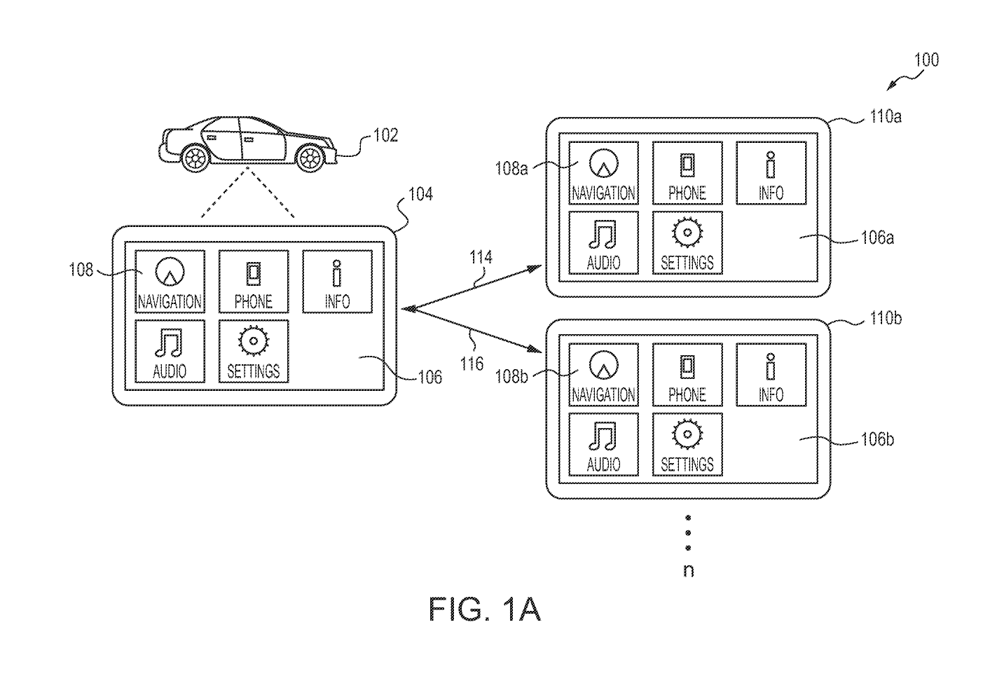

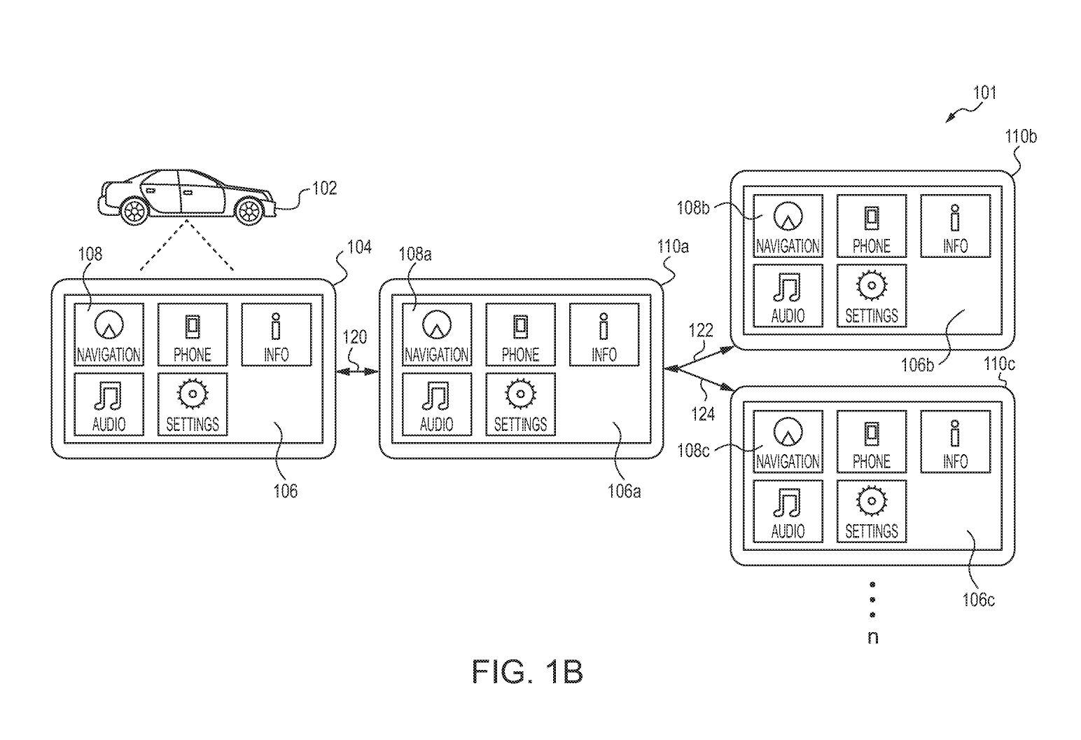

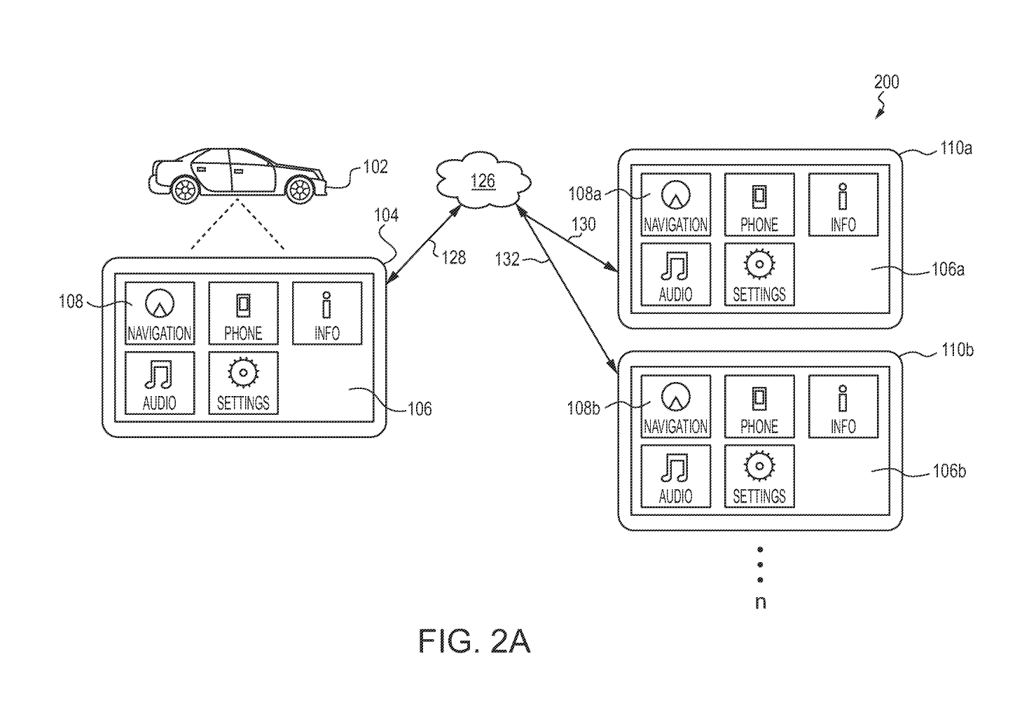

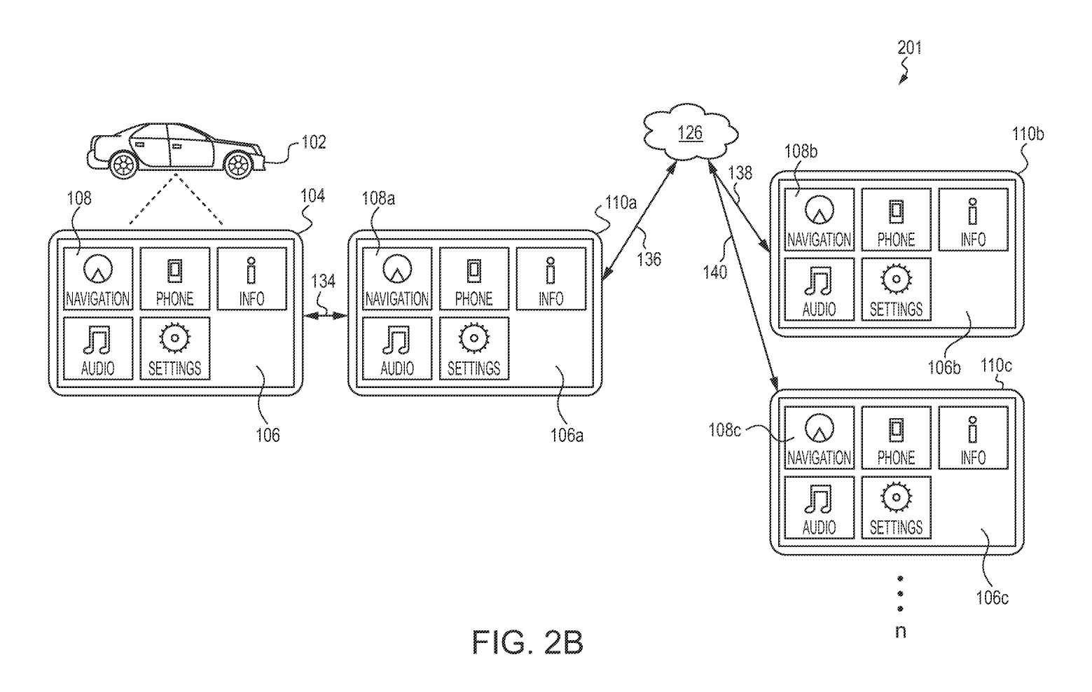

Referring now to the drawings, wherein the showings are for purposes of illustrating one or more exemplary embodiments and not for purposes of limiting same, FIGS. 1A, 1B, 2A and 2B illustrate exemplary systems 100, 101, 200 and 201 in which embodiments of vehicle interface extension and control discussed herein can operate. In particular, the systems 100, 101, 200 and 201 illustrate different system architectures for effectuating vehicle interface extension and control. One having ordinary skill in the art will appreciate that the components of the architectures discussed below, as well as the components of other systems and software architectures discussed herein, can be combined, omitted or organized into different architectures for various embodiments.

In the embodiment illustrated in FIG. 1A, the system 100 includes a vehicle 102 with a telematics device 104 (e.g., a head unit, a vehicle computer system, a navigation unit). The telematics device 104 includes a human machine interface (HMI) 106 including hardware and software for providing user input and output as is known in the art. In the embodiment illustrated in FIG. 1A, the HMI 106 is presenting a plurality of applications 108 (i.e., a navigation application, a phone application, an info application, a media application and a settings application). When an application 108 is selected (e.g., through text, voice, touch and/or gesture user input) through the HMI 106, the telematics device 104 executes (i.e., launches) the selected application 108. It is appreciated that the HMI 106 can present other information, vehicle settings and applications as is known in the art.

The system 100 also includes a first portable device 110a and a second portable device 110b, which can be located inside the vehicle or outside of the vehicle 102. The first portable device 110a can be in the possession of a driver of the vehicle 102 or in the possession of a non-driver (e.g., a passenger, a friend, a family member) of the vehicle 102. Typically, a non-driver can be distinguished from a driver based on their seating position within the vehicle. In one embodiment, the first portable device 110a is a driver device and the second portable device 110b is a non-driver device. However, it is appreciated that the illustrated embodiments in FIGS. 1A, 1B, 2A and 2B can include any number of portable devices 110a to 110n in any combination of driver and non-driver devices.

Continuing reference to FIG. 1A, the HMI 106 of the telematics device 104 is extended for vehicle control to the first portable device 110a and the second portable device 110b. Specifically, the HMI 106 is mirrored to the first portable device 110a and the second device 110b resulting in an HMI 106a and an HMI 106b, respectively. The HMI 106a and the HMI 106b include a plurality of applications 108a and 108b. To extend the HMI 106 to the first and second portable devices 110a, 110b, the telematics unit 104 is operably connected for computer communication to the first portable device 110a via a communication link 114 and to the second portable device 110b via a communication link 116. The telematics unit 104 can establish connectivity to the first and second portable device 110a, 110b via the communication links 114, 116 using wireless technologies known in the art. In particular, in FIG. 1A, a peer-to-peer connection is shown for direct computer communication between the telematics unit 104 and the first and second portable devices 110a, 101b, although other network configurations can be used.

The communication links 114, 116 provide bi-directional computer communication between the telematics device 104 and the first and second portable devices 110a, 110b. In particular, the telematics unit 104 transmits an interface data stream from the telematics unit 104 to the first and second portable devices 110a, 110b via the communication links 114, 116. The interface data stream includes data, graphics and input events associated with the HMI 106 enabling the first and second portable devices 110a, 110b to mirror the HMI 106 and functionality associated with the HMI 106. Said in a different way, the HMIs 106a, 106b replicate the HMI 106 based on the interface data stream, thereby allowing a user (not shown) of the first and second portable device 110a, 110b to view and interact with the HMI 106a, 106b, respectively, in the same manner that a user (not shown) in the vehicle 102 can view and interact with the HMI 106. Accordingly, the HMI 106, is synchronized with the HMI 106a, 106b allowing mutual control of the vehicle 102 from the telematics unit 104 and first and second portable device 110a, 110b. In one embodiment, the portable devices 110a, 110b can communicate with each other. The communications can go through communication links 114, 116 or directly to one another, not shown. The communications can be managed by the telematics unit 104. In one embodiment, the communications can be mirrored between each other. Each change affecting one device would be mirrored on the other devices.

Referring now to FIG. 1B, another exemplary system 101 is shown. The system 101 includes components similar to those components discussed above with regards to system 100 (FIG. 1A) and for convenience, like components retain the same numbering. In the illustrated embodiment of FIG. 1B, the first portable device 110a is a driver device. The second portable device 110b and a third portable device 110c are other portable devices that may be located inside our outside of the vehicle 102. The portable devices 110b, 110c can be in the possession of a non-driver (e.g., a passenger, a friend, a family member).

In system 101, the HMI 106 is extended from the telematics unit 104 to the first portable device 110a via a communication link 120 and from the first portable device 110a to the other portable devices 110b, 110c via communication links 122, 124, respectively. Specifically, the telematics unit 104 transmits an interface data stream to the first portable device 110a which results in an HMI 106a with a plurality of applications 108a, mirroring the HMI 106 and the plurality of applications 108. The first portable device 110a then transmits the interface data stream to the other portable devices 110b, 110c, which results in an HMI 106b with a plurality of applications 108b and an HMI 106c with a plurality of application 108c, thereby mirroring the HMI 106 to the other portable devices 110b, 110c.

FIG. 2A illustrates another exemplary system 200. The system 200 includes similar components of systems 100 (FIG. 1A), 101 (FIG. 2B) and for convenience, like components retain the same numbering. In FIG. 2A, the vehicle interface extension and control is facilitated by a wireless communication network 126 in a client-server model. The wireless communication network 126 can include servers, data storage, web services, cloud computing services, and the like.

In system 200, the vehicle interface is extended from the telematics device 104 to the wireless communication network 126 via a communication link 128. The vehicle interface is then extended from the wireless communication network 126 to the first and second portable devices 110a, 110b, via the communication links 130, 132, respectively. Specifically, the telematics unit 104 transmits an interface data stream to the wireless communication network 126 and from the wireless communication network 126 to the first and second portable device 110a, 110b, which results in an HMI 106a with a plurality of applications 108a an HMI 106b with a plurality of applications 108b. Therefore, the HMI 106 and the plurality of applications 108 are mirrored on the first and second portable devices 110a, 110b.

FIG. 2B illustrates another exemplary operating system 201. The system 201 includes similar components of system 100 (FIG. 1A), 101 (FIG. 1B) and 200 (FIG. 2A) and for convenience, like components retain the same numbering. In FIG. 2B, the first portable device 110a and the wireless communication network 126 facilitate vehicle interface extension and control. In system 201, the HMI 106 is extended from the telematics device 104 to the first portable device 110a via the communication link 134. The HMI 106 is further extended from the first portable device 110a to the wireless communication network 126 via a communication link 136 and then to the other portable devices 110b, 110c via communication links 138, 140, respectively.

Specifically, the telematics unit 104 transmits an interface data stream to the first portable device 110a which results in an HMI 106a with a plurality of applications 108a, mirroring the HMI 106 and the plurality of applications 108. The first portable device 110a then transmits the interface data stream to the wireless communication network 126 and from the wireless communication network 126 to the other portable devices 110b, 110c. This results in an HMI 106b with a plurality of applications 108b and an HMI 106c with a plurality of application 108c, thereby mirroring the HMI 106 to the other portable devices 110b, 110c.

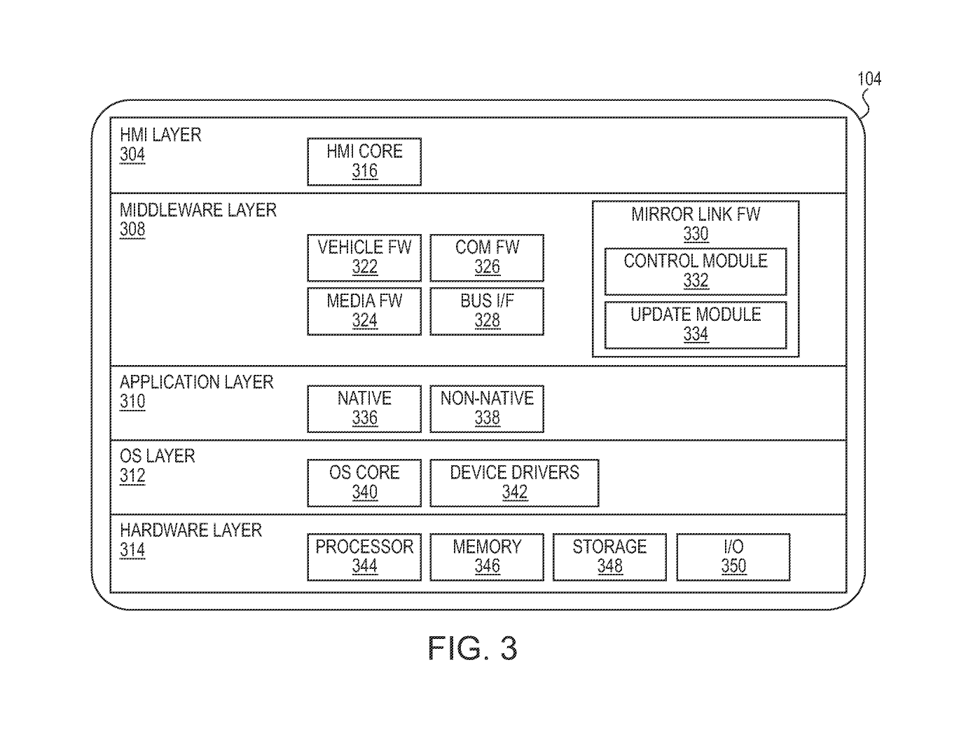

Referring now to FIG. 3, an exemplary system architecture diagram of the telematics device 104 of FIGS. 1A, 1B, 2A, 2B is illustrated. The telematics device 104 includes a human machine interface (HMI) HMI layer 304, a middleware layer 308, an application layer 310, an operating system layer (OS) layer 312 and a hardware layer 314. The HMI layer 304 includes an HMI core 316 that defines the screen design, screen transitions and actions of the HMI 106 from HMI input and other data. The HMI core 316 can also include action handling for voice, touch, gesture and/or motion recognition.

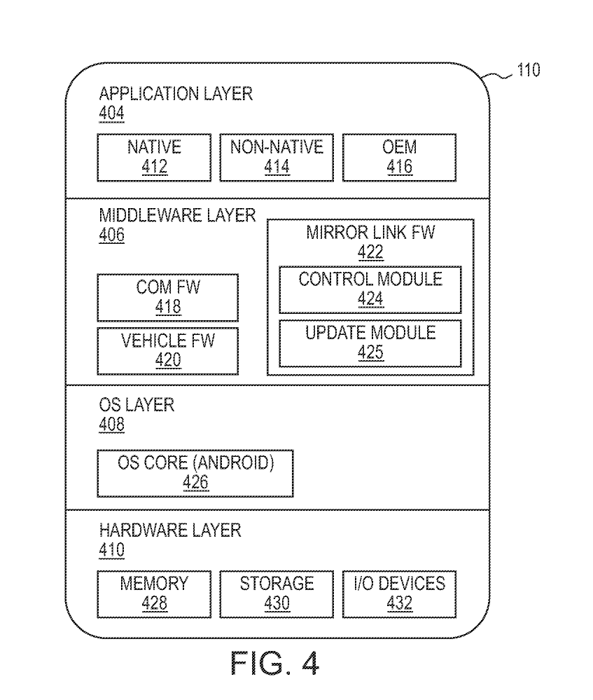

The middleware layer 308 includes libraries, frameworks and application programming interfaces (API) to realize the functions of the telematics device 104. The middleware layer 308 includes a vehicle framework (FW) 322 for handling vehicle data and monitoring the state of vehicle 102. The media framework (FW) 324 manages media and graphics of the telematics device 104. The mirror link framework 330 (FW), with the mirror link framework 422 (FIG. 4) includes provisions for sharing media and audio between the telematics device 104 and other portable devices (e.g., the portable device 110). Additionally, the mirror link framework 330 includes a control module 332 and an update module 334, which facilitate vehicle interface extension and control between the telematics device 104 and the other portable devices as discussed in further detail herein.

The communication framework 326 (com FW) includes provisions for connectivity and communication with external servers and devices. In particular, the communication framework 326 establishes connections between the telematics device 104 and the other portable devices 110a-110n as discussed above with reference to FIGS. 1A, 1B, 2A and 2B. The bus interface 328 (I/F) provides and manages access to vehicle data via, for example, a vehicle bus (not shown). The application layer 310 includes native applications 336 as well as non-native (e.g., third party) applications 338. For example, the applications 108 (FIGS. 1A, 1B, 2A and 2B) are examples of native applications 336.

The OS layer 312 includes an operating system core 340 (e.g., Windows) and device drivers 342 specific to the telematics device 104. The hardware layer 314 includes provisions for management and access of hardware resources. Hardware resources can include a processor 344, a memory 346, a storage 348 and vehicle specific input/output devices 350.

Referring now to FIG. 4, an exemplary system architecture of the portable device 110 (i.e., the portable devices 110a-110n of FIGS. 1A, 1B, 2A and 2B) is illustrated. The portable device 110 can be a driver device or non-driver device and can be located inside a vehicle or outside of a vehicle (i.e., the vehicle 102). The portable device 110 includes an application layer 404, a middleware layer 406, an operating system (OS) layer 408 and a hardware layer 410.

The application layer 404 includes native applications 412, non-native applications 414 (e.g., third party) and original equipment manufacturer (OEM) applications 416 which run on the portable device 110. The OEM applications 416 include specific applications provided by a vehicle OEM for interaction with a vehicle (i.e., the vehicle 102) and the portable device 110, although it is appreciated said interaction can occur with or without the OEM applications 416.

The middleware layer 406 includes libraries, frameworks and application programming interfaces (API) for operating the portable device 110 and applications on the portable device 110. For example, the communication framework (com FW) 418 includes provisions for computer communication with external servers and device and application authentication. In particular, the communication framework 418 in conjunction with the communication framework 326 includes provisions for establishing a connection between the telematics device 104 and the other portable devices 110a-110n. The vehicle framework (car FW) 420 is a specific framework for communicating with a vehicle (i.e., the vehicle 102), handling vehicle data exchange and providing touch panel events between the portable device 110 and the telematics device 104 (FIG. 3).

The mirror link framework 422 (FW), with the mirror link framework 330 (FIG. 3) includes provisions for sharing media and audio between the other portable devices 110a-110n and the telematics device 104. In some embodiments, the mirror link framework 422 can include a control module 424 and an update module 425, similar to the control module 332 and the update module 334 of FIG. 3, which will be described in further detail herein.

The operating system (OS) layer 408 generally provides services for managing hardware and software resources of the portable device 110 and includes an OS Core 426, which can be, for example, Android, Mac OS, iOS, Mobile Linux, Symbian OS, Chrome OS, Windows Mobile, BlackBerry OS, Web OS, or other operating systems (e.g., mobile and computer operating systems) known in the art. Further, the hardware layer 410 includes provisions for direct management and access of hardware resources. The portable device 110 can include hardware such as a memory 428, a storage 430, and input/output devices 432 as known in the art.

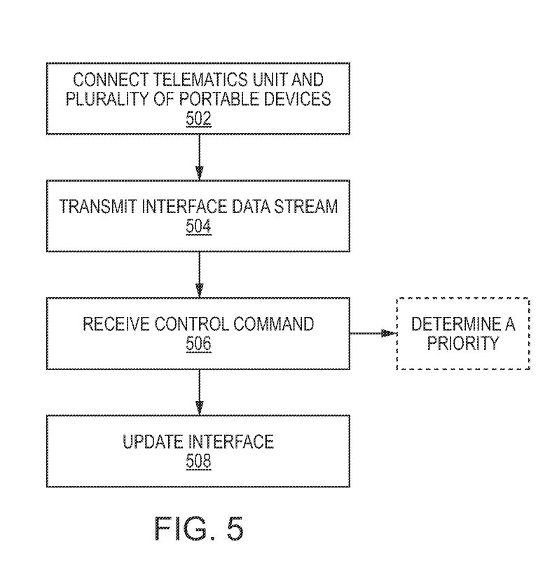

Referring now to FIG. 5, a computer implemented method is shown for extending and controlling a vehicle telematics unit. The method of FIG. 5 will be described with reference to the systems and components of FIGS. 1A, 1B, 2A, 2B, 3 and 4, though it is to be appreciated that the method could be used with other systems and components. Throughout the description of FIG. 5, an illustrative example will be discussed in relation to FIG. 1B and system 101, although it is appreciated that this illustrative example is exemplary in nature and could be applied to the other systems discussed herein.

The method begins at step 502 and includes establishing connections from a vehicle telematics device to a plurality of portable devices. The connections are operable to enable bi-directional computer communication between the vehicle telematics device and the portable devices. The connections can be established in various system architectures as discussed with FIGS. 1A, 1B, 2A and 2B above. The connections can be established automatically (e.g., wireless discovery) or initialized by input at the telematics device 104 or the portable devices 110a-110n as is known in the art.

Continuing reference to FIG. 5, at step 504 the method includes transmitting an interface data stream from the telematics device to the plurality of portable devices. In another embodiment, as shown in FIGS. 1B and 2B, the interface data stream is transmitted from the telematics device 104 to the first portable device 110a and forwarded from the first portable device 110a to the other portable devices 110b, 110c. The interface data stream includes data, graphics and user input events associated with the HMI 106 to enable the portable devices 110a-110n to mirror an interface (i.e., HMI 106) of the vehicle telematics device 104 and functionality associated with said interface. The mirror link framework 330, and in particular the control module 332, can be configured to transmit the interface data stream to the portable devices 110a-110n.

The method also includes, at step 506, receiving at the telematics device at least one control command from at least one portable device and executing the control command. The control command can include a user input received at a portable device and transmitted to the telematics device and/or a user input initiated at the telematics device. One or more control commands can be stored at the telematics device, for example, in a memory queue. In one embodiment, the control module 332 of the mirror link framework 330 is configured to receive and execute the control command. The execution of the control command controls the telematics device 104 and/or the vehicle 102 and updates the HMI 106 accordingly.

As an illustrative example and with reference to system 101 of FIG. 1B, the first portable device 110a can detect a user input through the HMI 116a. In one example, a user (not shown) selects a song A from an audio application (i.e., the plurality of applications 108a) on the first portable device 110a. The song selection is a control command generated by the first portable device 110a and transmitted to the telematics device 104. Specifically, the control module 424 transmits the control command to the control module 332. Then the control module 332 executes the control command causing the audio application to play song A in the vehicle 102. The control module 332 also updates the HMI 106 to reflect the execution.

The control command can also be initiated at the other portable devices 110b, 110c. For example a user (not shown) selects a song B from the portable device 110b. The control module 424 of the portable device 110b transmits the control command (i.e., the song selection) to the control module 424 of the first portable device 110a, which then forwards the control command to the control module 332 of the telematics device 104. The control module 332 then executes the control command causing the telematics device 104 to play the song B in the vehicle 102 and the HMI 106 to reflect the execution.

It is appreciated that the telematics device 104 can receive one or more control commands from one or more portable devices and store the control commands in a memory queue. The control commands can be execute according to an order received or, as will be discussed below, according to a priority. It is also appreciated that the control command can also be initiated at the telematics device 104. In one embodiment, upon receiving the control command, the driver is notified of the control command via the HMI 106. The driver can accept or reject the control command via the HMI 106 and the control command is executed based on the driver's input. In another embodiment, the control command includes graphics and data (i.e., an interface data stream) associated with the user input, thereby allowing a user of the other portable device 110b to “take over” the telematics device 104.

Continuing the reference to FIG. 5, step 506 can also include determining a priority of the control command based on a characteristic of the portable device, wherein the control command is executed based on the priority. The characteristics of the portable device can be any attribute of the portable device or applications on the portable device. For example, the characteristic of the portable device can be an owner of the portable device, a location of the portable device, a master/slave status of the portable device, an application status, among others.

The characteristic can be received by the telematics device 104 with the control command from one or more of the portable devices 110a-100n. Alternatively, the characteristic can be received by the telematics device 104 upon establishing a connection (i.e., step 502) with the portable devices 110a-100n. The characteristic can be stored at the telematics device 104, for example, in the storage 348. The priority can be determined by comparing the characteristic to a set of rules or user preferences set by a driver of the vehicle 102 and stored by the telematics device 104 (i.e., the storage 348) or accessed by the telematics device 104 (i.e., via the wireless communication network 126).

Referring again to the illustrative example, a driver of the vehicle 102 has set pre-defined user preferences regarding the vehicle extension and control of the telematics device 104 to the portable devices 110a-110n. The telematics device 104 receives a control command (i.e., selection of song A) from the first portable device 110a and a control command from the other portable device 110b (i.e., selection of song B). Along with the control command, one or more characteristics of the portable device 110a and the portable device 110b are received by the telematics device 104. The telematics device 104, and in particular, the control module 332, determines a priority of the control commands based on the characteristics received. For example, a characteristic of the first portable device 110a can be a location that indicates that the first portable device 110a is located in the vehicle 102. The characteristic of the other portable device 100b can be a location that indicates that the portable device 110b is not located in the vehicle 102. The control module 332 determines based on the user preferences that a control command from a portable device located in the vehicle has priority over a control command from a portable device located outside of the vehicle. Accordingly, the control module 332 plays (i.e., executes) song A (i.e., the control command from the first portable device 110a) before song B (i.e., the control command from the other portable device 110b).

Referring again to FIG. 5, at step 508, the method includes updating the interface data stream upon detecting a change event. A change event can include any event detected by the HMI 106 or a control command received from the portable devices 110a-110n. The interface data stream is modified based on the change event and the modified interface data stream is transmitted to the portable devices 110a-110n, thereby providing real-time mirroring to the portable devices 110a-110n. In one embodiment, the update module 334 of the mirror link framework 330 is configured for updating the interface (i.e., HMI 106) of the telematics device 104 based on the control command and extending the updated interface to the plurality of portable devices 110a-110n upon detecting a change event. Accordingly, mutual control of the telematics device 104 is provided to one or more portable devices allowing the driver and non-drivers to share control and information with the vehicle 102.

It will be appreciated that various implementations of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method for extending and controlling a vehicle telematics unit, comprising:
establishing connections from a vehicle telematics device to a plurality of portable devices;
transmitting an interface data stream from the telematics device to the plurality of devices, the interface data stream enabling the portable devices to mirror an interface of the vehicle telematics device and functionality associated with said interface; and
updating the interface data stream upon detecting a change event.

2. The method of claim 1, including receiving at the telematics device at least one control command from at least one portable device and executing the at least one control command.

3. The method of claim 2, wherein the change event is detected upon receiving the at least one control command.

4. The method of claim 1, wherein the change event is an event initiated at the telematics device.

5. The method of claim 2, including determining a priority of at least two control commands based on a characteristic of the portable device, wherein the at least two control commands are executed based on the priority.

6. The method of claim 1, wherein at least one of the portable devices is a non-driver portable device.

7. A method for extending and controlling a vehicle telematics device, comprising:
establishing a connection from a vehicle telematics device to a first portable device and from the first portable device to a plurality of other portable devices;
transmitting an interface data stream from the telematics device to the first portable device;
transmitting the interface data stream from the first portable device to the other portable devices, wherein the interface data stream enables the first portable device and the other portable devices to mirror an interface of the vehicle telematics device and functionality associated with said interface;
updating the interface data stream upon detecting a change event.

8. The method of claim 7, including receiving at the telematics device via the first portable device at least one control command from the first portable device or the other portable devices and executing the at least one control command.

9. The method of claim 8, wherein the change event is detected upon receiving the at least one control command.

10. The method of claim 8, wherein the first portable device is a driver portable device.

11. The method of claim 10, wherein the other portable devices are non-driver portable devices.

12. The method of claim 8, including determining a priority of at least two control commands based on a characteristics of the first portable device or the other portable devices.

13. The method of claim 7, wherein the change event is an event initiated at the telematics device.

14. A system for extending and controlling a vehicle telematics device, comprising:
a vehicle telematics device operably connected to a plurality of portable devices; and
a mirror link framework for extending an interface of the telematics device to the plurality of portable devices, the mirror link framework comprising:
a control module for transmitting an interface data stream from the telematics device to the plurality of devices, the interface data stream enabling the portable devices to mirror an interface of the vehicle telematics device and functionality associated with said interface, and
an update module for updating the interface of the telematics device based on the control command and extending the updated interface to the plurality of portable devices upon detecting a change event.

15. The system of claim 14, wherein the control module includes receiving at least one control command from each of the portable devices and executing the at least one control command.

16. The system of claim 14, wherein at least one of the portable devices is a non-driver portable device.

17. The system of claim 14, wherein the update module includes determining a priority of at least two control commands based on a characteristic of the portable device, wherein the control commands are executed based on the priority.

18. The system of claim 14, wherein the change event is an event initiated at the vehicle telematics device.

19. A non-transitory machine-readable medium for providing executable instructions that causes a computer to execute a method for extending and controlling a vehicle telematics device, the method comprising:
establishing connections from a vehicle telematics device to a plurality of portable devices;
transmitting an interface data stream from the telematics device to the plurality of devices, the interface data stream enabling the portable devices to mirror an interface of the vehicle telematics device and functionality associated with said interface; and
updating the interface data stream upon detecting a change event.

20. The non-transitory machine-readable medium of claim 19, including receiving at the telematics device at least one control command from the plurality of portable devices and executing the at least one control command, thereby allowing mutual control of the telematics device.
